(19) United States
(12) Patent Application Publication
(10) Pub. No.: US 2025/0301956 A1
(43) Pub. Date: Oct. 2, 2025

(54) SAME-BAG COLLECTION AND DISPOSAL OF LAWN-WASTE CLIPPINGS

(71) Applicant: James BRIM, Marietta, GA (US)

(72) Inventor: James BRIM, Marietta, GA (US)

(21) Appl. No.: 19/091,031

(22) Filed: Mar. 26, 2025

Related U.S. Application Data
(60) Provisional application No. 63/569,952, filed on Mar. 26, 2024.

(51) Int. Cl. A01D 43/063; B65F 1/00

(52) U.S. Cl. CPC A01D 43/0636; B65F 1/0006; B65F 2240/138; B65F 2250/105; B65F 2250/108

(57) ABSTRACT

A lawn-waste bagging system includes a disposable bag and a bag holder. The bag holder mounts to a lawn mower, supports the bag, and includes an attachment system that removably attaches the bag to the holder. And the disposable bag includes an array of holes with a configuration so that during mowing use the lawn-waste clippings do not pass through the holes but air does. In use, when the bag is full of the lawn-waste clippings, the bag is removed and disposed of, without transferring the lawn-waste clippings to another bag, and a new bag is attached to the holder for continued mowing use. Other embodiments include the disposable bags provided separately for use with the bag holder, the bag holder and/or attachment system provided separately for use with the bag holder, and the method of using the bagging system.

### CROSS-REFERENCE TO RELATED APPLICATIONS

This application claims priority to U.S. Patent Application Ser. No. 63/569,952 filed Mar. 26, 2024, which is incorporated herein by reference.

### TECHNICAL FIELD

The present invention relates generally to the field of lawn maintenance, and more particularly to collecting and disposing of lawn clippings from lawn mowers.

### BACKGROUND

In the lawncare field, lawn mowers with attachable bags systems are commonly used to mow grass and collect the grass clippings. This is more efficient than raking and bagging the grass clippings after mowing, and it avoids the unsightliness of leaving the grass clippings strewn about on the ground. The bag systems include a reusable bag (typically woven of polymeric or other synthetic fibers) for collecting and containing the grass clippings, and a holder that removably attaches to the mower and supports the bag in a position extending laterally from the mower. When the bag fills with grass clippings, the bag must be removed from the mower and emptied into a disposable refuse bag (for disposal of the transferred grass clippings), and then the emptied bag must be reattached to the mower (for continued mowing or storage).

Drawbacks of this approach include that emptying the grass clippings from the reusable bag into the disposable refuse bag involves time and hassle. Also, the process of pouring the clippings into another bag can be tricky for one person to do, with the result being sometimes the clippings are spilled all over the ground. As such, improvements that address these drawbacks are desirable.

### SUMMARY

Generally described, the present invention relates to same-bag collection and disposal of lawn-waste clippings. In example embodiments, a bagging system that mounts to a lawn mower and collects lawn-waste clippings includes a disposable bag and a bag holder. The disposable bag includes an array of holes formed into and through the bag, with the holes configured so that during mowing use the lawn-waste clippings do not pass through the holes but air does. And the bag holder is adapted to mount to the mower and support the bag, with the bag holder including an attachment system that removably attaches the bag to the holder. In use, when the bag is full of the lawn-waste clippings, the bag is removed and disposed of, without transferring the lawn-waste clippings to another bag, and a new bag is attached to the holder for continued mowing use. Other embodiments include the disposable bags provided separately for use with the bag holder, the bag holder and/or attachment system provided separately for use with the bag holder, and the method of using the bagging system.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a system for bagging grass clippings according to an example embodiment of the invention, showing a disposable bag and a bag holder of the bagging system removably attached to a lawn mower in use mowing a lawn.

FIG. 2 is a perspective side view of the bagging system of FIG. 1, showing the disposable bag and the bag holder in a disassembled arrangement.

FIG. 3 is a perspective side view of the disposable bag of FIG. 1, shown in a folded and flat arrangement.

FIG. 4 is a perspective side view of the disposable bag of FIG. 1, shown in an unfolded/opened arrangement and positioned upright resting on the ground.

FIG. 5 is a perspective end view of the bagging system of FIG. 1, showing the disposable bag removably attached to the bag holder.

FIG. 6 is a perspective end view of the bag holder of FIG. 1, showing clamp mechanisms that removably attach the disposable bags to the bag holder for use.

FIG. 7 is a side detail view of a portion of the bag holder of FIG. 6, showing one of the clamp mechanisms in a closed position.

FIG. 8 shows the bag holder portion of FIG. 7, with the clamp mechanism in an open position.

FIG. 9 is a side detail view of a portion of the disposable bag and bag holder of FIG. 1, showing slits in the disposable bag to enable fitting onto the bag holder for use.

FIG. 10 is a side detail view of a portion of a disposable bag and bag holder according to another embodiment of the invention, showing an alternative clamp mechanism that removably attaches the disposable bags to the bag holder for use.

FIG. 11 is a perspective side view of a disposable bag and bag holder according to yet another embodiment of the invention, showing another alternative clamp mechanism that removably attaches the disposable bags to the bag holder for use.

### DESCRIPTION OF EXAMPLE EMBODIMENTS

Generally described, the present invention relates to improved articles, devices, systems, and methods for bagging lawn-waste clippings. These articles, devices, systems, and methods can be used with conventional lawn mowers, both push (walk-behind) mowers and riding mowers, with lawn-waste discharge openings at the rear, side, or other location of the mower. As used herein, the term lawn-waste clippings includes grass clippings as well as other yard refuse that has been clipped (cut off and/or up) by a lawn mower, e.g., weeds, leaves, and twigs.

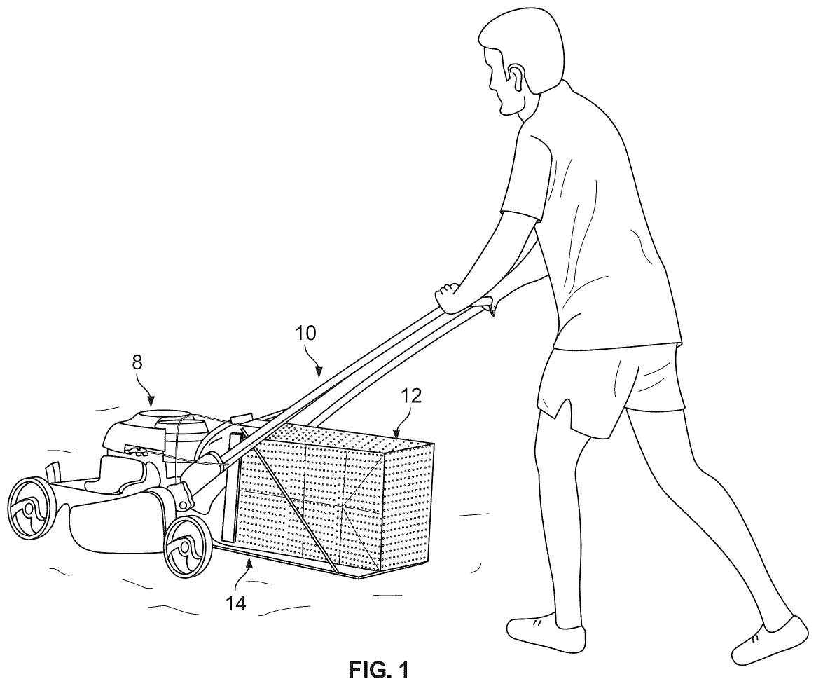

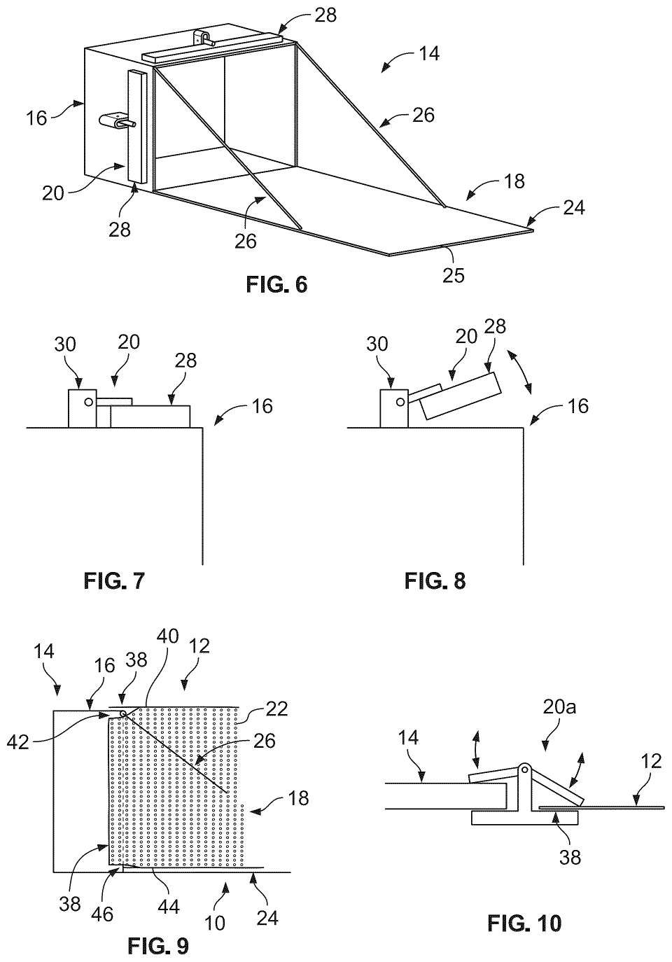

FIGS. 1-9 show a system 10 for bagging lawn-waste clippings according to an example embodiment. The system includes a disposable bag 12 and a bag holder 14. The bag 12 and the bag holder 14 are specially designed to enable the same (single) bag 12 to be used on a lawn mower 8 to collect the lawn-waste clippings directly from the mower 8 and to also be used to store the clippings for disposal. Because the same single bag 12 provides this dual functionality, there is no need to transfer the clippings from a first reusable bag for lawn-waste collection to a second/separate disposable bag for lawn-waste storage and disposal.

The bag holder 14 removably attaches to the mower 8 and supports the bag 12 in a position extending laterally from the mower during use of the mower to cut grass. The bag holder 14 includes a transition chute 16 that is positioned between the (side or rear) discharge chute of the mower 8 and the bag 12, a support frame 18 that extends from the transition chute 16 and supports the bag 12, and an attachment system 20 that removably attaches the bag 12 to the transition chute 16.

The bag holder 14 can be of a conventional or modified design. The transition chute 16 defines an interior passageway with inlet and outlet end openings. The clippings are received from the discharge chute of the mower 8 and into/through the inlet opening of the transition chute 16, and then discharged out/through the outlet opening of the transition chute 16 and into bag 12.

These components of the bag holder 14 can all be of a conventional design. In the depicted embodiment, the transition chute 16 is rectangular and formed by four interconnected rectangular metal sidewalls in a rectangular box-shaped arrangement forming a peripheral boundary wall defining the interior passageway with inlet and outlet end openings. In other embodiments, the transition chute has another regular or irregular shape (e.g., trapezoidal, oval, or varied along its length), is sized differently (e.g., larger or smaller), is formed by other peripheral wall members (e.g., panels or sheets), and/or is made of other materials (e.g., plastic), for optimized use with a conventional rectangular disposable refuse bag 12 or a modified disposable refuse bag (e.g., circular, otherwise non-rectangular, or no pre-defined shape when opened for use).

Also, the frame 18 includes a support member 24 extending laterally from the transition chute 16. The frame support member 24 is typically a bottom support member 24 and the frame 18 typically also includes at least one tension member 26. The bag 12 typically rests upon the bottom support member 24 (at least after some use when the bag 12 is loaded with some clippings) and typically is not supported from above. The bottom support member 24 extends laterally away from the bottom of the transition chute 16 and is configured to support the bag 12 rested upon it, including the full weight of the bag 12 and clippings when the bag 12 is full of (dry or damp) clippings. And the tension member 26 extends between the bottom support member 24 and the transition chute 16 to support the bottom support member 24 in position when it's supporting the bag 12 full of clippings.

These components of the bag holder 14 can all be of a conventional design. In the depicted embodiment, the bottom support member 24 is a rectangular metal plate that has at least as large a footprint as the bag 12 being supported (i.e., the bag 12 does not extend beyond the outer edges of the bottom support member 24 during use). And the at least one tension member 26 is two angled metal tension rods that are spaced apart and that extend between the two top corners of the rectangular transition chute 16 and a location on the bottom plate that is spaced from the transition chute 16 (e.g., closer to the distal/free end of the bottom support member 24 than the opposite proximal/chute-attached end, as depicted).

In other embodiments, the support member has another regular or irregular shape (e.g., oval or circular), is sized differently (e.g., longer or shorter, and/or wider or narrower), is formed by other support members (e.g., latticed, slatted, or otherwise non-solid/non-continuous and thus vented), is made of other materials (e.g., plastic), and/or is otherwise configured (e.g., a top support rod or panel for suspending the bag, side supports for suspending the bag, or a box-shaped support for the bag), for optimized use with a conventional rectangular disposable refuse bag 12 or a modified disposable refuse bag (e.g., circular, otherwise non-rectangular, or no pre-defined shape when opened for use). The bottom support member being vented advantageously allows airflow out of the sidewall 32 of the bag 12 that is facing down toward, and typically resting upon, the bottom support member 24. And the least one tension member can extend between other locations of the transition chute and the frame or even other parts of the bag holder, only one or more than two of them can be provided, they can be provided by cables, chains, bars, panels, or other elements that function to provide the functionality described herein, and/or they can be excluded in embodiments in which their structural reinforcement is not needed.

In addition, the bag holder 14 includes the attachment system 20 to removably attach the bag 12 to the transition chute 16 of the mower 8. The attachment system 20 is typically of a different design than conventional mechanisms that removably attach conventional reusable bags to lawn mowers. The attachment system 20 secures the bag 12 to the transition chute 16 when it's in a locked position so that when the mower 8 is operating the bag 12 does not fly off. And the attachment system 20 unlocks to quickly and easily release the bag 12 from the transition chute 16 when the bag 12 is full.

The attachment system 20 includes one or more components that removably attach to and secure the bag 12 in place on the bottom support member 24 and adjacent the transition chute 16 with the bag open side 36 in communication with the outlet opening of the transition chute 16. The attachment components 20 removably attach and secure to the sidewalls 32 of the bag 12 adjacent the open end of the bag 12 (i.e., they attach to the peripheral lip portions 38 of the bag 12), without the need for any cooperating component of the attachment system 20 on the bag 12. Typically, attachment system components 20 are mounted onto the transition chute 16, and the bag 12 is free of any component of the attachment system 20.

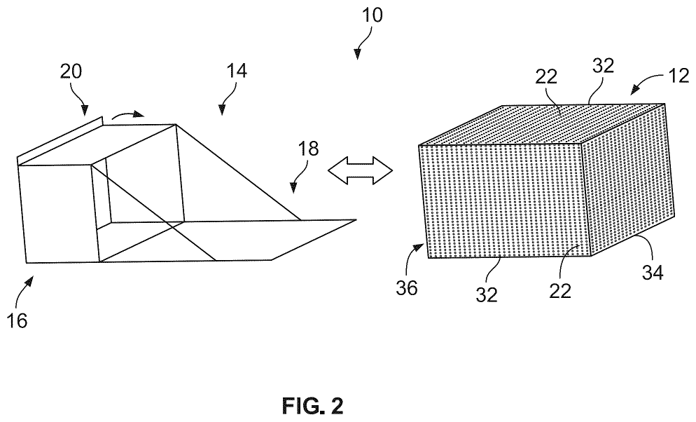

In the depicted embodiment, the attachment system 20 includes one or more clamping mechanisms mounted onto the transition chute 16. For example, there can be three of the clamping mechanisms 20, with one each located on one of the top, left, and right sides of the transition chute 16. The depicted clamping mechanisms 20 each include a clamping element 28 and a clamp mount 30 (e.g., the depicted pivotal locking mount), as shown in FIGS. 2 and 7-8. The clamping elements 20 are moveable (e.g., pivotal) between an open position not securing the bag 12 to the transition chute 16 (FIG. 7) and a clamping position securing the bag 12 to the transition chute 16 (FIG. 8). The pivotal mounts 30 are each attached to the transition chute 16, enable the clamping elements 28 to pivot between their open and clamping positions, and include a lock feature (conventional, not shown) that retains the clamping elements 20 in their clamping positions during use of the mower 8 and bag 12. The lock feature can include a lock pin or latch, spring biasing, or another locking feature, and it can be excluded in embodiments in which the clamping or other attachment system 20 provides sufficient holding/securing forces that a lock in not needed.

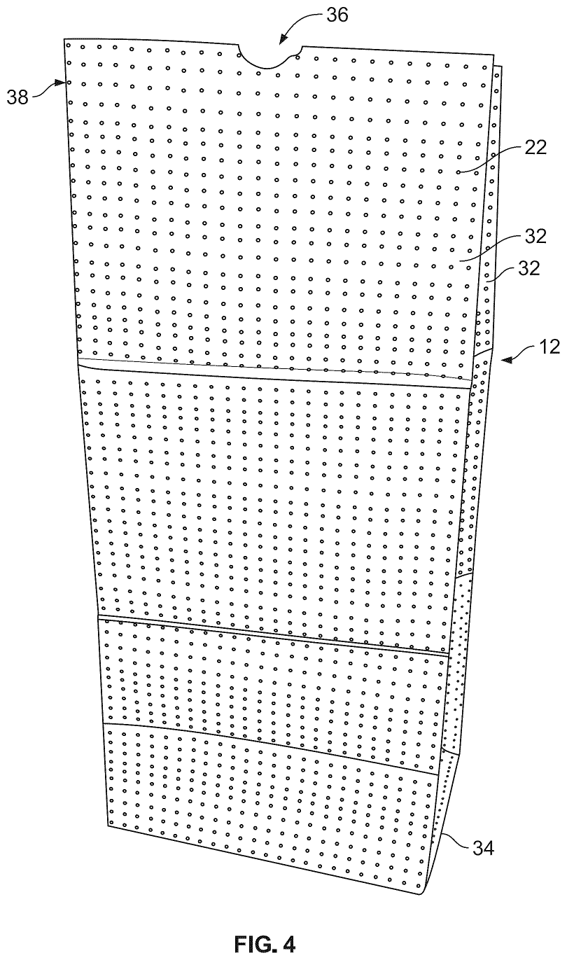

In the depicted embodiment, the clamping mechanisms 20 are entirely mounted onto the transition chute 16, so that the bags 12 include no cooperating component that couples with the clamping mechanisms 20 to secure the bags 12 to the transition chute 16. Instead, the clamping mechanisms 20 on the transition chute 16 clamp and secure directly to the featureless flat peripheral lip portion 38 of the bag 12 adjacent its open top 36 (with the top being up when the bag 12 is standing upright on the ground as shown in FIG. 4). This avoids the need for any clamping or other coupling component on the bags 12, which are disposable, thereby avoiding the cost of including such added features on each and every disposable bag.

The clamping elements 28 can be for example a conventional wooden, plastic, or metal slat or bar. And the pivotal mounts 30 can be for example a metal locking hinge or latch that releasably locks in the clamping position to secure the bag 12 to the transition chute 16. The clamping mechanisms 20 of the depicted embodiment hold 150 lbs and are well-suited for this use.

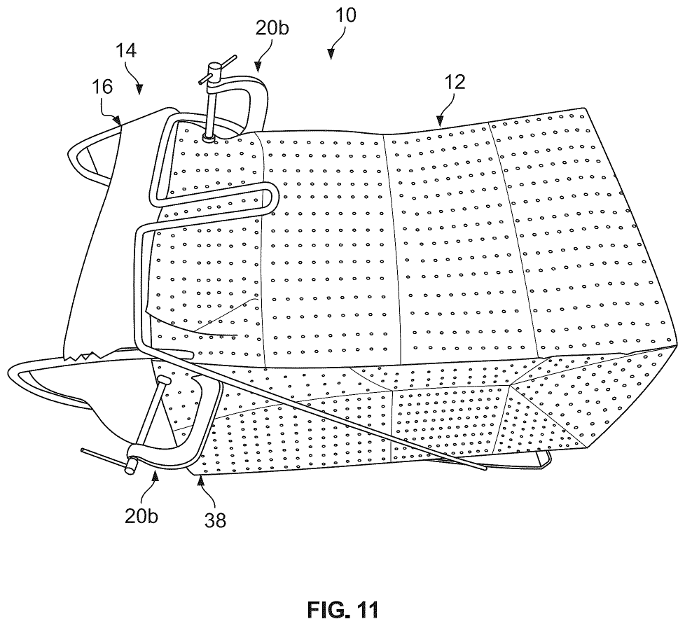

In other embodiments, other types and designs of clamping mechanisms are used, for example the alternative clamping mechanism 20a shown in FIG. 10 (positioned between and pivotally clamping to the chute 16 on one side and the bag 12 on the opposite side, with two clamping elements and one pivotal clamp mount), the alternative pivotal clamping mechanism 20b shown in FIG. 11 (vise clamps, with two clamping elements and a U-shaped clamp mount unattached to the transition chute in the open position), and other alternative clamping mechanisms including clamping elements and clamp mounts (e.g., enabling linear movement of the clamping elements). And in other embodiments, other types and designs of attachment systems (other than clamping mechanisms) are used, for example a peripheral strap, belt, or band that is tightened around the free end of the bag 12 and the chute 16 to secure the bag 12 in place for use and loosened to remove the bag 12. Further, the attachment systems can be provided with or without a locking feature, as may be desired.

The bag 12 is a disposable refuse bag, not a reusable bag for repeated use over the life of the lawnmower. So instead of collecting the clippings in a conventional reuseable mower-attached bag and then emptying the lawn-waste clippings from that collection bag 12 into a separate disposable refuse bag, the disposable bag 12 and clippings together are disposed of (with the clippings still inside the bag 12). The bag 12 can be of a conventional disposable refuse bag, for example made of a paper or other material that is compostable.

In the depicted embodiment, for example, the bag 12 is a “lawn and leaf bag” that is commercially available from HOME DEPOT (Model No. HDLL 1635). This is a conventional yard refuse bag into which are placed lawn clippings emptied from lawn mower bags, raked leaves, picked up twigs, etc., with the holes 22 added to provide the functionality described here. This example bag 12 has a shell formed by four sidewalls (panels forming a rectangular shape) 32, a closed bottom wall panel 34, and an open top 36, with dimensions of 12 inches by 16 inches by 35 inches providing a 30-gallon capacity. The four sidewalls 32 form the open top 36 with a 12-inch by 16-inch opening (with the top and bottom being up and down when the bag is standing upright on the ground as in FIG. 4). These opening dimensions are sufficiently conforming/close to the dimensions of the depicted conventional transition chute 16 that the bag 12 can be fit onto the transition chute 16 and secured there by the attachment system 20.

In other embodiments, bags and holders with other opening dimensions can be used, provided they enable mating/securing use to provide the functionality described herein. Such other bags include those with different opening dimensions selected to fit onto other bag holders with other transition chute dimensions, with the bag opening dimensions selected such that the bags fit onto the transition chute so they can be secured in place by the attachment system 20 and so substantially all of the clippings are directed into the bag (i.e., there are no more than negligible gaps between the bag and the holder).

As another suitable example of the bag 12 a lawn and leaf bag that is commercially available from TRUE VALUE (Model No. TV306274 by Ampac Mobile Holdings). This example bag 12 has the same configuration, except with dimensions of 9.5 inches by 14.25 inches by 17 inches forming a 9.5-inch by 14.25-inch opening. To fit this size of bag 12 onto the bag holder 14, the transition chute 16 can be selected with the needed dimensions to conform to the bag opening to allow this bag to fit onto it and/or one or more of the bag corners can be slitted open (to fit onto a larger chute 16) or compressed (folded, crumbled, etc., to fit into a smaller chute 16). Also, this bag typically can be used without cutting down its length to fit onto the bottom support plate 24.

Additionally, the bag 12 is made of a biodegradable material, for example a paper material such as kraft paper, that is sufficiently flexible that the bag can be bended and folded, with sufficient minimal stiffness that the bag can stand upright (see FIG. 4), as is common for yard refuse bags. The stiffness also enables the bag 12 to hold its shape, when empty, when it's stood upright and during use. The paper material can be for example a two-ply wet-strength paper construction for durability and tear resistance. In other embodiments, the bag can be made of other biodegradable or non-biodegradable materials, such as a plastic, a resilient polymeric material, another non-woven material, or another conventional bag material.

As noted, this example bag 12 has a length of 35 inches as standardly provided by the supplier. To fit onto the depicted conventional frame 18 (i.e., so substantially the entire length of the bag 12 is resting on and supported by the bottom support member 24, and not extending unsupported over the free/outer end 25 of the bottom support member 24), a portion of the bag 12 can be removed from its free end (to form a new free end and thus peripheral lip portion 38). For use with the depicted conventional frame 18, for example, the standard bag 12 can be reduced (e.g., cut down) from 35 inches long to about 22 long (which is a common length for bag holder bottom plates). In other embodiments, bags and holders with other length dimensions can be used, provided they enable sufficient bag support to provide the functionality described herein. Such other bags include those provided with shorter lengths so they can be used with the depicted bag holder 14 without having to shorten them on-site, bags including a score line for reducing the bag length for use with the depicted bag holder 14 (or leaving the bag intact and using it for conventional yardwork, as may be desired), and bags each including a series of parallel score lines for reducing the bag length for use with different bag holders with different length frames.

Furthermore, the bag 12 is perforated with holes 22 formed in it in order to allow airflow out of the bag 12 during use. That is, the rotating blade of the mower 8 generates forced airflow (that carries the clippings) through the transition chute 16 and into the bag 12, and the bag 12 has the holes 22 to enable that airflow to escape the bag 12 (to significantly reduce/minimize the airflow forces urging the bag to fly off the holder 14).

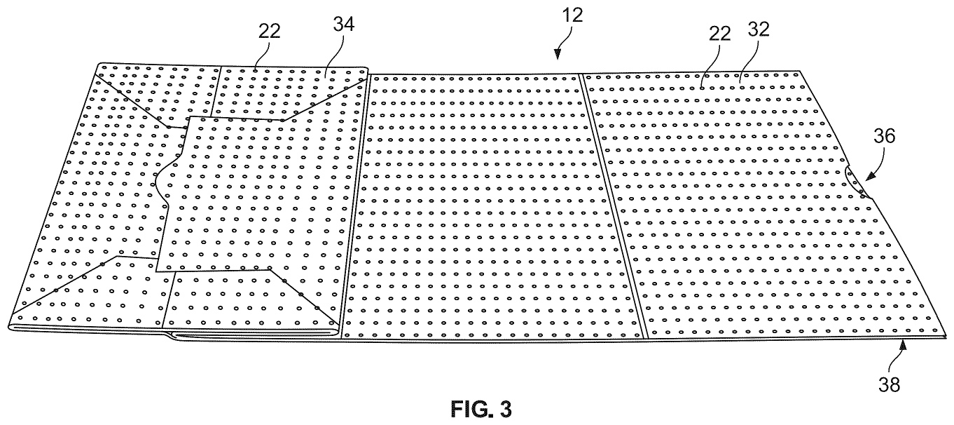

The holes 22 can be formed in the bag 12 by conventional techniques, for example laser cutting, as in the depicted embodiment. In other embodiments, the holes 22 can be formed by other conventional hole-cutting processes (including mechanical punching) or by other known techniques and equipment. The holes 22 can be formed in the bag 12 while the bag is in a fully folded and flat configuration (folded flat as in FIG. 3 and then folded over onto itself in thirds), as was done in the depicted embodiment. In other embodiments, the holes 22 can be formed in the bag 12 while the bag is in partially folded configuration (see FIG. 3; folded flat, but not then folded over onto itself in thirds) or an unfolded/open configuration (see FIG. 4).

The holes 22 can be formed in the bag 12 in a regular arrangement (e.g., an orderly array or pattern as in FIGS. 1-5) or in an irregular arrangement (e.g., randomly). In the depicted embodiment, the holes 22 are circular in shape, though other regular or irregular shapes (e.g., ovals, slits, or other elongated shapes/forms, or X-shaped, star-shaped, polygonal, or square) can be used. In the depicted embodiment, the holes 22 all have the same size and shape, though in other embodiments they can have a mix of different sizes and/or shapes.

In the depicted embodiment, the holes 22 are formed in all five (side and bottom) walls 32 and 34 of the bag 12. In other embodiments, the holes can be excluded on one sidewall (which is to be oriented downward facing/against the bottom support plate 24) and/or they can be excluded from the peripheral lip portions 38 of the bag 12 (which overlap with the transition chute 16, with some of these holes also overlapped with the clamping elements 28).

The area (size) of each of the holes 22 is selected to be small enough that the lawn-waste clippings (for typical cut-off lengths of lawnmower-cut grass blades, and typical grass blade widths) cannot pass through them. That is, the largest transverse dimension of the holes 22 (e.g., diameter for circular holes 22) is smaller than the largest transverse dimension (e.g., length or width) of the clippings. In this way, substantially all of the grass clippings (and other lawn-waste clippings) are retained in the bag 12 (an occasional clipping might be cut unusually small and slip out). At the same time, the size of each of the holes 22 is selected to be large enough that the grass (and other lawn-waste) clippings do not clog or otherwise block the holes 22 to a significant degree such that the airflow out of the bag 12 is restricted and the bag 12 can be blown off the holder 14 by the resultant increased airflow forces. As such, the bag 12 with the holes 22 essentially functions as a filter bag that allows airflow through it but retains the lawn-waste clippings inside it while the bag 12 is retained on the transition chute 16.

In the depicted embodiment, for example, the bag 12 has holes 22 that are circular and 7/64-inch (about 0.11 inch) in diameter, spaced apart by about 0.5 inches in a regular array, in rows of about 24 holes each, on all five (side and bottom) walls 32 and 34 of the bag 12, for a total of about 3500 holes 22. Having the holes 22 on all four bag sidewalls 32 allows the bag 12 to be positioned on the 14 holder in any orientation, so it doesn't matter which sidewall 32 is facing down toward and/or against the bottom support plate 24 (the holes 22 on that sidewall are typically covered/blocked (at least partially) by the bottom support plate 24 in embodiments with solid/unvented bottom support plates), with the exposed (uncovered) holes 22 on the other four walls 32 and 34 providing the total area of holes 22 for the needed airflow to provide the functionality described herein. In other embodiments, the holes have a larger area and fewer rows and/or number, or a smaller area and more rows and/or number, to provide the total hole area needed for the airflow functionality described herein.

The 7/64-inch holes are small enough that the clippings do not typically escape but large enough that the clippings do not significantly restrict escaping airflow. In other embodiments, the holes are slightly smaller and more of them are provided, or they are slightly larger and fewer of them are provided, to result in about the same total airflow area. Also, the hole size and number are selected to be sufficiently large to provide the needed total area of holes 12 for airflow, and the hole size, number, and spacing are selected to be sufficiently small that the bag walls 32 and 34 retain structural strength sufficient to not tear or otherwise fail during use. Example optional ranges of the hole size includes diameters of about 0.10 inch to about 0.12 inch, about 0.09 inch to about 0.13 inch, and about 0.08 inch to about 0.14 inch. For bags 23 with smaller holes 22, more of them can be provided at closer spacings, and vice versa.

In addition, the total (cumulative) area (size) of the exposed (uncovered) holes 22 is selected to enable sufficient airflow out of the bag 12 during mowing use so that the resultant airflow forces urging the bag 12 to detach from the holder 14 are insignificant. That is, there may be no such resultant airflow forces on the bag 12, or there may be some but only negligible such forces, or such forces may be moderate but still insignificant relative to the securing (e.g., clamping) capabilities/forces of the attachment system 20. The covered holes 22 are those through which airflow is substantially blocked, for example holes 22 in the downward-facing sidewall 32 blocked by the bottom support plate 24 (and/or clippings in the bag 12 and supported upon that sidewall) and/or holes 22 in the peripheral lip portion 38 blocked by the transition chute 24 (and/or the clamping elements 28), with the exposed holes 22 thus being the remaining holes which are not blocked and thus through which the forced air flows.

The total area of the exposed holes 22 in the depicted embodiment (with all holes of the same area) is the area of each hole times the number of exposed holes, thus excluding covered (unexposed) holes. Each of the circular holes 22 has a diameter of 7/64-inch (about 0.11 inch), with an area of 0.0095 in². And there are about 2650 exposed holes 22 (excluding the holes 22 on the peripheral lip portions 38 and one of the sidewalls 32). Accordingly, the total area of the exposed holes 22 in each of the depicted bags 12 is about 13.25 in². Also, the porosity ratio of the total area of the exposed holes 22 to the total exposed surface area of the bag 12 (about 1070 in², excluding one of the sidewalls 32 that will be facing downward against the bottom support plate 24) is about 1.2 percent. In other embodiments, the total area of the exposed holes 22 is about 12.0 in² to about 14.5 in², about 10.0 in² to about 14.5 in², or about 12.0 in² to about 16.5 in², and the porosity ratio is about 0.9 percent to about 1.5 percent, about 1.0 percent to about 2.0 percent, or about 0.5 percent to about 1.2 percent.

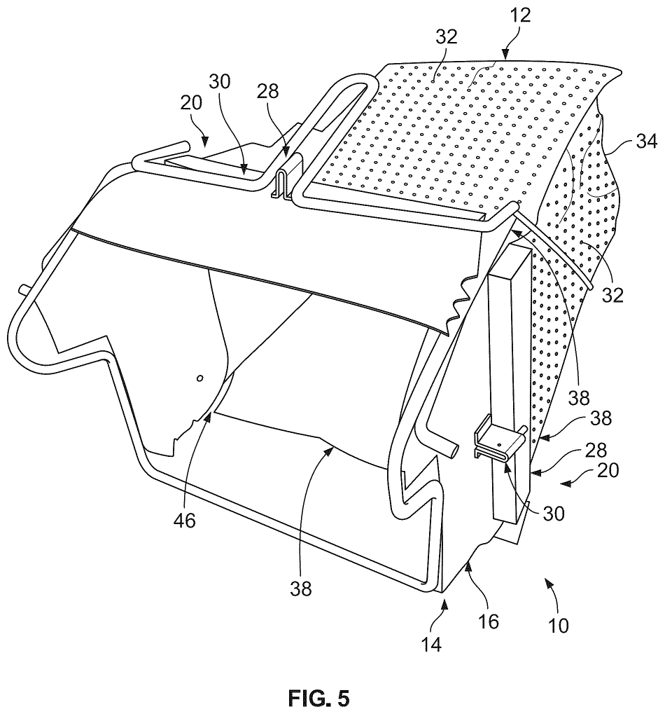

Furthermore, for use with conventional bag holders 14 of the type depicted, the bag 12 can be slit at its open-end corners to better fit onto the frame 18. As shown in FIG. 9, for example, two corners 40 (at opposite side edges of one long sidewall 32) are upper-positioned (with the bag installed for use) and each include a slit 42 so that one long sidewall of the bag 12 and two short sidewalls can fit outside of (around) the transition chute 16 of the bag-holder frame 18, with the frame tension rods 26 received into the slits 42. In some embodiments, the frame tension rods 26 are not included, or they are but they attach to the transition chute 26 at a location farther from its outlet opening, so that the slits 42 are not needed. As further shown in FIG. 9, for example, the other two corners 44 are lower-positioned (with the bag installed for use) and each include a slit 46 so that the other long sidewall 32 can be fit inside of the transition chute 16 on top of the bottom support plate 24 (see also FIG. 5).

The slits 42 and/or 46 can be included on the bags 12 as provided, or they can be excluded from the bags 12 as provided and made on-site as needed (depending on the particular bag holder being used). For on-site slitting, the bags 12 can be provided with score lines to facilitate the on-site slitting. The slits 42 and 46 also enable the bag 12 with the 12-inch by 16-inch opening to be used with a transition chute 16 having the same (or substantially the same) dimensions or slightly larger dimensions.

Having described the bagging system 10, its method of use will now be described, with the method being another aspect of the invention. For use, one of the disposable bags 12 is mounted to the bag holder 14 using the attachment system 20 to form the bagging system 10, the bagging system 10 is mounted to the mower 8, and the mower 8 is operated to cut grass. When the disposable bag 12 is full (to the user's satisfaction) 12 of lawn-waste clippings, the disposable bag 12 is removed from the bag holder 14 (and thus the mower 8), and the lawn-waste clippings are disposed of. The lawn-waste clippings can be disposed of by placing the disposable bag 12 and clippings at the curbside for pickup, by composting on site, or otherwise, without needing to transfer the clippings out of the disposable bag 12 they were originally collected in. Then a new one of the disposable bags 12 is mounted to the bag holder 14 (and thus the mower 8) for continued mowing, and the process is repeated until the job is completed.

Other aspects of the invention include disposable bag articles provided separately from and ready for use with a bag holder device, bag holder devices provided separately from and ready for use with a disposable bag article, and attachment systems provided separately from and ready for retrofit use with an existing bag holder, with the disposable bag articles, the bag holder devices, and the attachment systems being of the type described herein or having substantially the same structural design and substantially the same functionality.

In this way, aspects of the invention provide advantages over prior bagging systems. These advantages include significant saving in time and hassle, as well as no spilling of the clippings (because there is no need to transfer them out of the bag they were collected in) and no opportunity for the bag to spill on the ground when you replace it.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the specific sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A bagging system for mounting to a lawn mower and collecting and disposing of lawn-waste clippings, comprising:
a disposable bag with an array of holes formed into and through the bag, wherein the holes are configured with a size and shape so that during mowing use the lawn-waste clippings do not pass through the holes but air does; and
a bag holder that is adapted to mount to the mower and support the bag, wherein the bag holder includes an attachment system that removably secures the bag to the bag holder during mowing use;
wherein in mowing use, when the bag is full of the lawn-waste clippings, the bag is removed from the bag holder and disposed of, without transferring the lawn-waste clippings to a separate bag for disposal, and a new one of the bags is attached to the bag holder for continued mowing use.

2. The bagging system of claim 1, wherein the attachment system includes one or more clamp mechanisms.

3. The bagging system of claim 2, wherein the clamp mechanisms include clamp components that are all mounted to the bag holder.

4. The bagging system of claim 3, wherein the bag includes sidewalls forming an open top with a flat peripheral lip portion of the sidewall adjacent the top opening, wherein the peripheral lip portion is clamped onto by the clamping mechanism to removably secure the bag to the bag holder, wherein the bag includes no component of the clamp mechanism and no component other than the flat peripheral lip portion that cooperates with the clamp mechanism to removably secure the bag to the bag holder.

5. The bagging system of claim 1, wherein the bag holder includes a transition chute and a support member, wherein the transition chute mounts to the mower and the bag removably secures to it, the attachment system is mounted to the transition chute, and the support member extends laterally from the transition chute and supports the bag during mowing use.

6. The bagging system of claim 5, wherein the support member is a bottom support member that extends laterally from a bottom of the transition chute and supports the bag from below during mowing use.

7. The bagging system of claim 5, wherein the transition chute and the bag are rectangular with conforming dimensions so that the bag fits onto the transition chute and is removably secured there by the attachment system.

8. The bagging system of claim 1, wherein the disposable bag is made of a biodegradable material.

9. The bagging system of claim 8, wherein the bag is made of kraft paper.

10. The bagging system of claim 1, wherein the holes each have a size that is smaller than each of the lawn-waste clippings to retain the lawn-waste clippings within the bag during mowing use.

11. The bagging system of claim 10, wherein all the holes combined have a total hole area that is sufficiently large to enable airflow to escape the bag so that the bag is not forced off the bag holder by trapped airflow.

12. The bagging system of claim 10, wherein the bag includes sidewalls and a bottom wall, wherein the holes are formed in all of the side walls and the bottom wall.

13. The bagging system of claim 1, wherein the bag holder includes a rectangular transition chute that mounts to the mower and to which the bag removably secures, wherein the bag includes four sidewalls that form a rectangular open top and that intersect to form four corners, and wherein the corners include slits that enable one bag sidewall to be positioned inside the transition chute and the remaining sidewalls to be positioned outside the transition chute when the bag is removably secured to the transition chute.

14. A bagging method using the bagging system of claim 1, comprising:
removably securing the bag to the bag holder for mowing use;
after mowing use, when the bag is full of the lawn-waste clippings, removing the bag from the bag holder;
disposing of the removed bag full of the lawn-waste clippings, without transferring the lawn-waste clippings to a separate bag for disposal; and
removably securing a new one of the bags to the bag holder for continued mowing, wherein the same single bag is used to collect and dispose of the lawn-waste clippings.

15. The bagging method of claim 1, wherein the bag holder includes a rectangular transition chute that mounts to the mower and to which the bag removably secures, and wherein the bag includes four sidewalls that form a rectangular open top and that intersect to form four corners, the bagging method further comprising:
slitting at least two of the corners; and
fitting the bag onto the transition chute with one bag sidewall positioned inside the transition chute and the remaining sidewalls positioned outside the transition chute when the bag is removably secured to the transition chute.

16. A bagging system for mounting to a lawn mower and collecting and disposing of lawn-waste clippings, comprising:
a disposable bag with an array of holes formed into and through the bag, wherein the holes are configured so that during mowing use the lawn-waste clippings do not pass through the holes but air does, wherein the holes each have a size that is smaller than each of the lawn-waste clippings to retain the lawn-waste clippings within the bag during mowing use, wherein all the holes combined have a total hole area that is sufficiently large to enable airflow to escape the bag so that the bag is not forced off the bag holder by trapped airflow, and wherein the bag is made of a biodegradable kraft paper, wherein the bag includes sidewalls forming an open top with a flat peripheral lip portion of the sidewall adjacent the top opening; and
a bag holder that is adapted to mount to the mower and support the bag, wherein the bag holder includes a transition chute, a bottom support member, and an attachment system, wherein the transition chute mounts to the mower, the bottom support member extends laterally from a bottom of the transition chute and supports the bag from below during mowing use, and the attachment system is mounted to the transition chute and removably secures the bag to the bag holder during mowing use, wherein the attachment system includes components that are all mounted to the bag holder and that removably secure to the peripheral lip portion of the bag, wherein the bag includes no component of the attachment system and no component other than the flat peripheral lip portion that cooperates with the attachment system to removably secure the bag to the bag holder;
wherein in mowing use, when the bag is full of the lawn-waste clippings, the bag is removed from the bag holder and disposed of, without transferring the lawn-waste clippings to a separate bag for disposal, and a new one of the bags is attached to the bag holder for continued mowing use.

17. A disposable bag of a bagging system for mounting to a lawn mower and collecting and disposing of lawn-waste clippings, the bagging system including a bag holder that mounts to the mower and to which the bag removably secures, the bag comprising:
sidewalls, a bottom wall, and an opposite open top, with an array of holes formed into and through the sidewalls and/or bottom wall, wherein the sidewalls form the open top with a flat peripheral lip portion of the sidewalls adjacent the open top, wherein the holes are configured so that during mowing use the lawn-waste clippings do not pass through the holes but air does, wherein the holes each have a size that is smaller than each of the lawn-waste clippings to retain the lawn-waste clippings within the bag during mowing use, wherein all the holes combined have a total hole area that is sufficiently large to enable airflow to escape the bag so that the bag is not forced off the bag holder by trapped airflow,
wherein the bag is made of a biodegradable kraft paper,
wherein the peripheral lip portion of the bag removably secures to an attachment system of the bagging system, wherein the bag includes no component of the attachment system and no component other than the flat peripheral lip portion that cooperates with the attachment system to removably secure the bag to the bag holder, and
wherein in mowing use, when the bag is full of the lawn-waste clippings, the bag is removed from the bag holder and disposed of, without transferring the lawn-waste clippings to a separate bag for disposal, and a new one of the bags is attached to the bag holder for continued mowing use.

18. The disposable bag of claim 17, wherein the bag and the transition chute are rectangular with conforming dimensions so that the bag fits onto the transition chute and removably secures there by the attachment system.

19. The disposable bag of claim 17, wherein the holes are cut into the bag when the bag is folded flat.

20. A bagging method using the bagging system of claim 17, comprising:
removably securing the bag to the bag holder for mowing use;
after mowing use, when the bag is full of the lawn-waste clippings, removing the bag from the bag holder;
disposing of the removed bag full of the lawn-waste clippings, without transferring the lawn-waste clippings to a separate bag for disposal; and
removably securing a new one of the bags to the bag holder for continued mowing, wherein the same single bag is used to collect and dispose of the lawn-waste clippings.
